(19) United States
(12) Patent Application Publication
(10) Pub. No.: US 2014/0252856 A1
(43) Pub. Date: Sep. 11, 2014

(54) POWER CONSUMING MANAGEMENT SYSTEM

(71) Applicant: Chung Shan Institute of Science and Technology, Armaments Bureau, M.N.D, (US)

(72) Inventors: Chih-Hsien Chung, Taoyuan County (TW); Jung-Zong Wu, Taoyuan County (TW); Yu-Min Liao, Taoyuan County (TW); Kuo-Sheng Fu, Taoyuan County (TW); Ywh-Ming Gong, Taoyuan County (TW)

(73) Assignee: Chung Shan Institute of Science and Technology, Armaments Bureau, M.N.D, Taoyuan County (TW)

(21) Appl. No.: 13/787,629

(22) Filed: Mar. 6, 2013

(51) Int. Cl. H02J 4/00

(52) U.S. Cl. CPC H02J 4/00
USPC 307/35; 307/31

(57) ABSTRACT

A power consuming management system installed between a power outlet and at least one load includes an electricity meter connected between the power outlet and the at least one load for detection of power consumption and distribution of power to the at least one load, a charger connected to the power outlet, a power saving element connected to the charger, an energy recovery module connected to the power saving element and the electricity meter and a controller connected to the charger, the power saving element, the energy recovery module and the electricity meter to form a loop.

### BACKGROUND OF THE INVENTION

1. Field of the invention This invention is related to a power consuming management system, and more particular, to a management system capable of integrating the contract capacity in an energy recovery system (ERS) for optimal use of the energy.

2. Description of Related Art

Contract capacity is the predetermined maximum power rate agreed upon between the power plant and the user, such as a community, in order to maintain steady power load for the power plant. If there is a power surge exceeding the agreed contract capacity, the power plant has the right to fine the user. In order to avoid the fine and maintain the power usage under the contract capacity, numerous control systems are developed. For example, installation a wattmeter before the installation of an electricity meter so that whenever there is a power surge exceeding the contract capacity, an orderly shutdown of devices is commenced to reduce the power load. When the power load is back to normal, a reboot procedure is then proceeded to bring back necessary devices to normal functioning Such control system requires the installation of electricity meters as well as sensing devices on the user end to properly undergo a power control, which is quite inconvenient to the user in numerous situations such as shutting down the air conditioner in high noon.

A different control system is called energy recovery system, ERS. This ERS is able to recover power consumed in load resistance back to the user circuit via recovery circuit to allow devices (load) in the circuit to have the priority to use the power and reduce the dependency to the power plant, which is quite environment friendly and able to reduce electricity cost. However, this ERS can only recover the power originally consumed in the load and has no feedback feature to determine whether a power conservation process or a charging process should be commenced according to the variety of loads.

Still a different control system is the programmable logic controller, PLC, to control the operation of the generator. The generator under the influence of PLC is able to generate power exceeding the contract capacity for various loads. However, because of the variety of loadings existing in daily routine, parameters of the power supply system cannot remain constant and that brings difficulties to the power plant. Furthermore, this PLC can only produce power and cannot save or store extra power generated.

### SUMMARY OF THE INVENTION

The primary objective of the present invention is to provide an power consuming management system capable of saving power in off-peak times in a power saving element and provide the saved power to the circuit via a power recovery module when the loading is approaching the previously predetermined contract capacity. An electricity meter installed in the system senses the current power consumption and reports the same back to a controller to determine the quantity of power that should be retracted from the power saving element. Therefore, when the consuming power exceeds the supplementary power initiation value, an equal quantity of power from the power saving element is extracted by the controller and sent to the circuit to avoid exceeding the contract capacity. When the cost for electricity is relatively cheap in off peak times and the power consumption is lower than the predetermined charging initiation value, power is sent to the power saving element by the controller.

In order to accomplish the aforementioned objective, the electric power consuming management system in accordance with the preferred embodiment of the present invention has an electricity meter connected between a power outlet and at least one load to detect power consumption and adjust power distribution to the at least one load, a charger connected to the power outlet, a power saving element connected to the charger, an energy recovery module connected to the power saving element and the electricity meter and a controller connected to the charger, the power saving element, the energy recovery module and the electricity meter to form a closed loop.

A further objective of the present invention is that the power in off peak times may be saved in the power saving element via the charger through the assistance of the controller such that in the situation where the electricity meter detects power consumption exceeding a first predetermined value, the electricity meter sends a first signal to the controller to stop the charger from continuing charging and to supply supplementary power from the energy recovery module and extract power from the power saving element so as to reduce power consumption from the power plant and in the situation where the power consumption is lower than the first predetermined value, the electricity meter sends a second signal to the controller to command the charger to proceed with charging process and resume normal power supply.

It is noted that the firs predetermined value is a supplementary power initiation value.

It is further noted that when the electricity meter detects the power consumption is lower than a second predetermined value, a third signal is sent to the controller by the electricity meter to command the charger to stop charging and when the electricity meter detects the power consumption is higher than the second predetermined value, a fourth signal is sent to the controller to command the charger to commence charging to the power saving element.

It is noted that the second predetermined value is a charging initiation value.

### BRIEF DESCRIPTION OF THE DRAWINGS

The invention, as well as its many advantages, may be further understood by the following detailed description and accompanying drawings.

FIG. 1 is a schematic framework of the system of the present invention;

FIG. 2 is a schematic diagram showing the supplementary power supply of the present invention; and

FIG. 3 is another schematic diagram showing the supplementary power supply of the present invention.

### DETAILED DESCRIPTION OF THE INVENTION

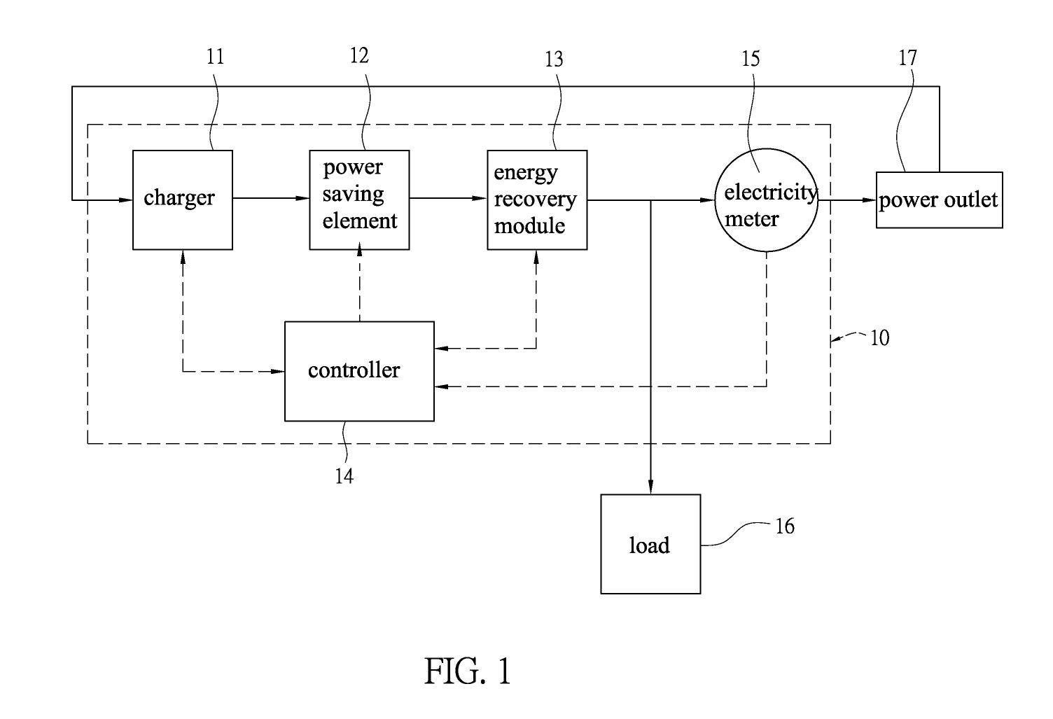

With reference to FIG. 1, the power consuming management system 10 in accordance with the present invention includes an electricity meter 15 connected between a power outlet 17 and at least one load 16 to detect power consumption and adjust power distribution to the at least one load, a charger 11 connected to the power outlet 17, a power saving element 12 connected to the charger 11, an energy recovery module 13 connected to the power saving element 12 and the electricity meter 15 and a controller 14 connected to the charger 11, the power saving element 12, the energy recovery module 13 and the electricity meter 15 to form a closed loop.

It is to be noted that the power supply is divided into two categories, one is from the electricity meter 15 directly to the load and the other is from the charger 11, the power saving element 12, the energy recovery module 13 and then the electricity meter 15 to the load. When the electricity meter detects the power consumption exceeds a supplementary power initiation value, the electricity meter isolates the normal power supply from the load and sends out a first signal to the controller 14 to command the charger 11 to stop charging process. In the meantime, the power required by the at least one load 16 is provided by the power saving element 12 and the energy recovery module 13 to reduce dependency upon the normal power supply. When the electricity meter 15 detects the power consumption is lower than the supplementary power initiation value, the electricity meter 15 sends out a second signal to the controller 14 to command the charger to commence charging process and resume normal power supply.

In the preferred embodiment of the present invention, it is noted that the power recovery module 13, originally energy recovery system; ERS, is integrated with the charger 11 and the power saving element 12 and the controller 14 is adopted as the control for the contract capacity.

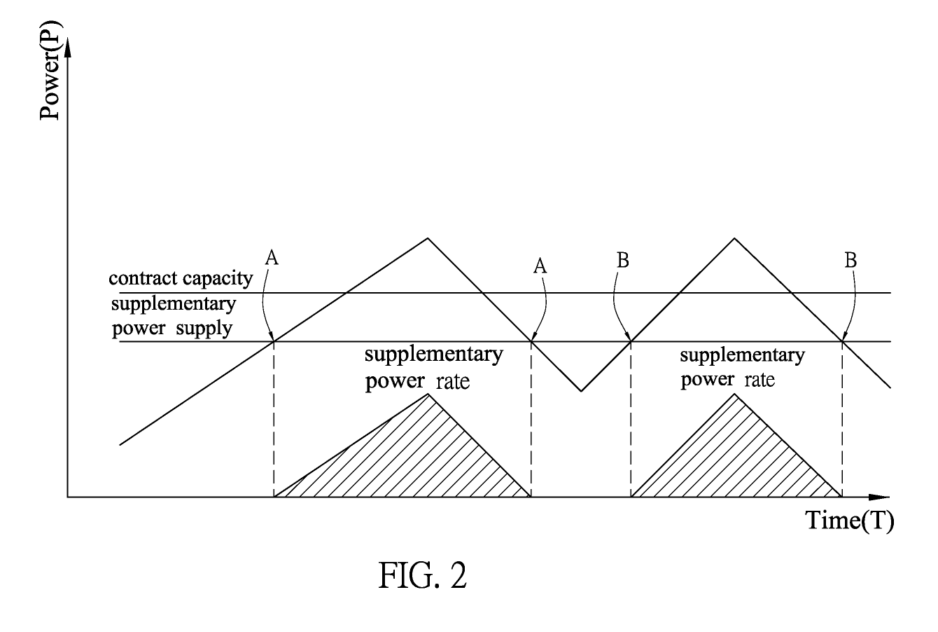

With reference to FIGS. 1 and 2, the horizontal axis represents time (t) and the vertical axis represents power (p). The wavelike line represents the detected power consumption rate. When the power consumption rate detected by the electricity meter accelerates and approaches the maximum contract capacity, B, i.e. exceeding supplementary power initiation value A, the controller 14 commands a quantity of power to be extracted from the power saving element and supplied to the loop to avoid exceeding the limitation of the contract capacity. When the power consumption rate detected by the electricity meter reaches the predetermined contract capacity, a portion of the power from the power saving element 12 is extracted in response to the reaction of the controller 14 via the power recovery module 13 to avoid inconvenience caused by the shutdown of devices due to the commencement of power conservation.

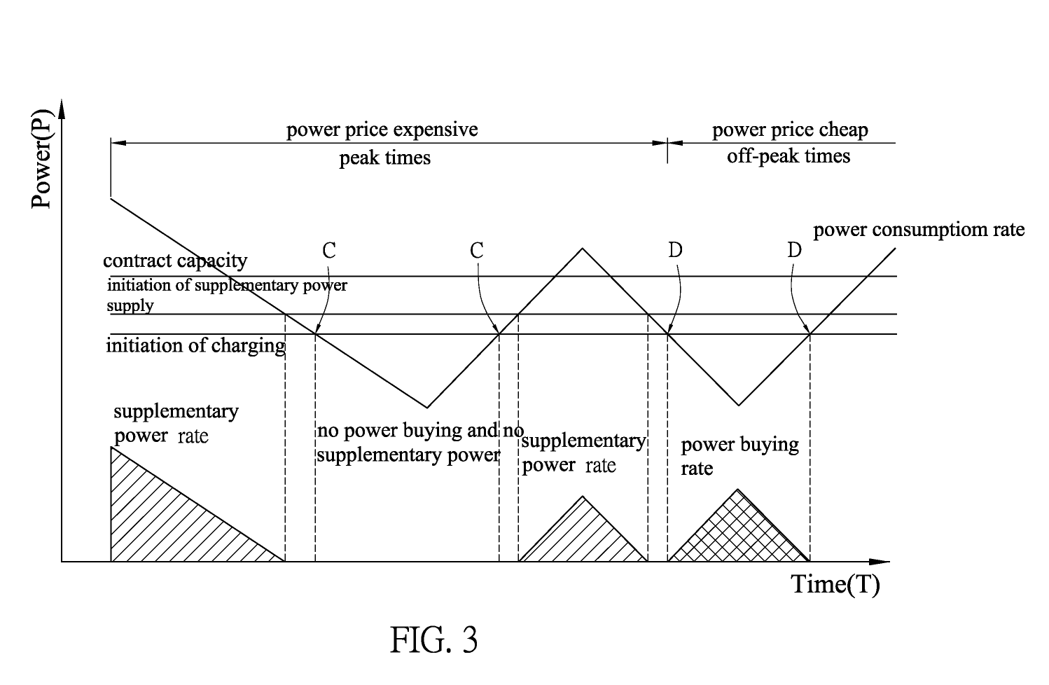

With reference to FIGS. 1 and 3, the horizontal axis represents time (t) and the vertical axis represents power (p). The wavelike line represents the detected power consumption rate. In the depiction of the drawing, it is noted that there are two different time zones, namely, peak times and off peak times. In the situation where the electricity meter 15 detects the power consumption rate is lower than the charging initiation value D, power in these off peak times may be saved in the power saving element by the charger, also called power buying rate.

In the situation where the electricity meter 15 detects the power consumption rate is lower than the charging initiation value C, the electricity meter 15 sends out a third signal to the controller 14 to stop the charging process by the charger. In the meantime, power is supplied normally by the power outlet and the charger is isolated from commencing charging process, i.e., no power buying or no power supplement.

In situation where the electricity meter detects the power consumption exceeds the charging initiation value C, a fourth signal is sent by the electricity meter 15 to the controller 14 to command the charger to initiate charging process o the power saving element. When in off peak times and the price for power is relatively cheap, the power consumption rate is reduced to a value lower than the power buying value D, the controller extracts power supplied by power outlet to the charger to the power saving element for backup power.

From the controlling of the controller 14 in response to different requirements in peak times and off-peak times, the power saving element is defined as a buffer according to limitation determined by the contract capacity so as to automatically adjust power distribution to meet the requirements defined between the power plant and the user.

In summary, the power consuming management system in accordance with the present invention has the following advantages:
1. Greatly reduce the possibility of being fined with the help of the programmable controller, the charger, the energy recovery system and the power saving element.
2. Providing a relatively stable power supply for the power plant and reducing variations between peak time power consumption and off-peak time power consumption.
3. Reducing the preparation of reserve margin as well as cost for preparation of hardware ready for the reserve margin.

What is claimed is:

1. An power consuming management system installed between a power outlet and at least one load, the power consuming management system comprising:
an electricity meter connected between the power outlet and the at least one load for detection of power consumption and distribution of power to the at least one load;
a charger connected to the power outlet;
a power saving element connected to the charger;
an energy recovery module connected to the power saving element and the electricity meter; and
a controller connected to the charger, the power saving element, the energy recovery module and the electricity meter to form a loop.

2. A method for power management in the power consuming management system as claimed in claim 1, comprising the steps of:
defining a first predetermined value for the electricity meter;
detecting power consumption rate;
saving power from the charger to the power saving element in a situation where the power consumption rate detected by the electricity meter is lower than the first predetermined value;
generating a first signal by the electricity meter in situation where the power consumption rate exceeds the first predetermined value to the controller to stop the charger from charging; and
generating a second signal by the electricity meter in situation where the power consumption rate is lower than the first predetermined value to the controller to commend the charger to proceed with charging.

3. The method as claimed in claim 2, wherein the first predetermined value is a supplementary power initiation value.

4. The method as claimed in claim 1 further comprising the steps of:
defining a second predetermined value for the electricity meter;
generating a third signal to the controller to command the charger to stop from charging in situation where the power consumption rate detected by the electricity meter is lower than the second predetermined value; and
generating a fourth signal to the controller to command the charger to commence the charger to proceed with charging in situation where the detected power consumption rate exceeds the second predetermined value.

5. The method as claimed in claim 4, wherein the second predetermined value is a charging initiation value.
